(19) United States
(12) Patent Application Publication
(10) Pub. No.: US 2018/0157685 A1
(43) Pub. Date: Jun. 7, 2018

(54) SYSTEMS AND METHODS FOR REMOTELY MONITORING DATABASES

(71) Applicant: Remote DBA Experts, LLC, Warrendale, PA (US)

(72) Inventors: Milton Flerl, Wexford, PA (US); Robert Brown, Wexford, PA (US)

(21) Appl. No.: 15/827,752

(22) Filed: Nov. 30, 2017

Related U.S. Application Data
(60) Provisional application No. 62/428,821, filed on Dec. 1, 2016.

(51) Int. Cl. G06F 17/30; G06F 11/30; G06F 8/38; G06F 9/44

(52) U.S. Cl. CPC G06F 17/30289; G06F 11/3034; G06F 9/4443; G06F 8/38; G06F 11/3051

(57) ABSTRACT

Disclosed is a computing architecture and method that provides consumers of remote database administrative services with access to both database monitoring and related service provision tools from a single, mobile point of access. The present disclosure provides an architecture that facilitates client access, from a single-point, to ticketing, monitoring, and request actions via a mobile device.

### TECHNICAL FIELD

The present disclosure relates to systems and methods for monitoring databases remotely. In particular, the present disclosure relates to systems and methods for facilitating service provisions for database administration functions through a mobile application.

### BACKGROUND

The present disclosure relates, generally, to database management systems. More particularly, the disclosure relates to a system architecture and method for deploying remote database administration. Specifically, the disclosure relates to a holistic approach to remotely manage relational database management systems. As used in this application, the term “database administration” is used in a broad sense to include database performance management, routine upkeep, and emergency response, as well as the service provision and monitoring tools used to communicate between database owners and remote service providers.

The present disclosure provides an architecture that facilitates client access, from a single-point, to ticketing, monitoring, and request actions via a mobile device.

The present disclosure also relates to an architecture and methodology for the enablement of mobile devices for client-side interactions in the provision of remote database administration services. In conventional systems, companies who contract with third party, remote database administrative service providers must utilize a combination of often-unintegrated technologies in order to interact with the service providers, even for routine maintenance and administrative tasks. These technologies usually include a combination of telephone, e-mail, enterprise-based ticketing, and enterprise monitoring systems that can potentially limit the ease with which standardized, repeatable tasks could be accomplished. For example, in conventional systems a user may use one application to monitor a database and a separate application for service provisions such as sending maintenance requests regarding the database based on information learned while monitoring the database. As the two separate applications do not communicate, in a conventional system the user may have to manually transfer data and information from one application to the other. Additionally, the user may experience delays between becoming aware of a potential problem using the monitoring application and being able to submit a service request using a service provider application.

Conventional methods and devices for database administration are believed to have significant limitations and shortcomings. Database management systems may also require ongoing administration to maintain the overall availability and performance of the database. This administration is highly specialized and personnel competent in the area are typically referred to as Database Administrators (DBAs). The provision of database administrative services is highly labor-intensive due to the variety of input that must be acknowledged, prioritized, and responded to, according to both the urgency of the issue and the parameters of the individual client's service level agreement (SLA).

Accordingly, for increased efficiency, there is a need for systems and methods that can integrate database monitoring with database service provision tools. There is also presently a need for a system and method to expand client interactions with the monitoring and service provision tools that are used by the provider of remote database administrative services. Such expansion will provide an additional mechanism through which consumers of remote database administrative services can interact with both service provision (ticketing, alert responses, etc.) and monitoring information.

Conventional systems did not integrate database monitoring with database service provisioning tools because monitoring information is typically viewed and consumed by different users than those who might utilize service provisioning tools for reporting problems and/or requesting services. For example, database monitoring tools are specialized to aggregate information from disparate sources to provide information to specialized technical individuals such as DBAs and IT administrators. Additionally, database service provisioning tools were specialized for usage by users with various technical backgrounds and configured to request services or report incidents.

Additionally, conventional database monitoring and service provisioning tools are highly specialized applications each having their own functionality and configurability. Conventional systems were unable to combine database monitoring with database service provisioning without diminishing the capabilities of one or both aspects. Additionally, while service provisioning tools utilize databases, monitoring tools are essentially a quantitative mechanism to proactively track network communication and performance in order to provide operator dashboards, reports, and alerts. For this reason, the functionalities of database monitoring and service provisioning tools are distinct. For at least these reasons, conventional systems did not integrate database monitoring with database service provisioning tools.

The inability to integrate database monitoring with database service provisioning tools prevented users from having insight into the entire lifecycle of a database including both monitoring and service aspects of the database. In conventional systems, while a user may receive a service monitoring alert based on a pre-defined check or threshold, the user may not have been able to initiate, monitor, or complete a corresponding maintenance operation to address the issue. Accordingly, there remains a need for an integrated database monitoring and service provisioning tool.

### SUMMARY

The present disclosure is related to a system including at least one user computing device including an application, and at least one server communicatively coupled to each of the at least one computing device via a network. The server(s) may include a non-transitory memory storing computer-readable instructions and at least one processor. The execution of the instructions, by the at least one processor, may cause the server to retrieve monitoring information related to a database via a monitoring application; retrieve service information related to a database via at least one of a service application and the at least one user computing device; generate integrated information that includes the monitoring information with the service information; and provide, on the at least one user computing device, a graphical user interface in the application that displays the integrated information.

In one embodiment, a system may include a database operations center having a service application and a monitoring application, an integration hub having at least one server communicatively coupled to the database operations center, and a separate computing device having an application. The at least one server may include a non-transitory memory storing computer-readable instructions and at least one processor. Execution of instructions, by the at least one processor, may cause the at least one server to: receive from the separate computing device at least one request; determine whether the received request is a monitoring request or a service request; query the service application of the data operations center for service information if it is determined that the received request is the service request and receive the service information; query the monitoring application of the data operations center for monitoring information if it is determine that the received request is the monitoring request and receive the monitoring information; display on a graphical user interface of the application of the separate computing device integrated information related to the service application and the monitoring application; and update a graphical user interface on the application of the separate computing device with at least one of the service information and the monitoring information.

### BRIEF DESCRIPTION OF THE DRAWINGS

FIG. 1 illustrates computer architecture for a system with integrated database monitoring and service provisions according to an aspect of the present disclosure.

FIG. 2 illustrates a graphical user interface for a mobile application providing integrated database monitoring and service provisions according to an aspect of the present disclosure.

FIG. 3 also illustrates a graphical user interface for a mobile application providing integrated database monitoring and service provisions according to an aspect of the present disclosure.

FIG. 4 also illustrates a graphical user interface for a mobile application providing integrated database monitoring and service provisions according to an aspect of the present disclosure.

FIG. 5 also illustrates a graphical user interface for a mobile application providing integrated database monitoring and service provisions according to an aspect of the present disclosure.

FIG. 6 also illustrates a graphical user interface for a mobile application providing integrated database monitoring and service provisions according to an aspect of the present disclosure.

FIG. 7 also illustrates a graphical user interface for a mobile application providing integrated database monitoring and service provisions according to an aspect of the present disclosure.

FIG. 8 also illustrates a graphical user interface for a mobile application providing integrated database monitoring and service provisions according to an aspect of the present disclosure.

FIG. 9 also illustrates a graphical user interface for a mobile application providing integrated database monitoring and service provisions according to an aspect of the present disclosure.

FIG. 10 also illustrates a graphical user interface for a mobile application providing integrated database monitoring and service provisions according to an aspect of the present disclosure.

### DETAILED DESCRIPTION

The present disclosure is directed towards an application that provides integrated database monitoring and service provisions. In particular, the application may be run on a mobile device that is part of a computer architecture system that facilitates access, from a single-point, to ticketing, monitoring, alerting and request actions via a mobile device. The application may enable technical consumers of database monitoring information to have real-time insight into the entirety of their monitored database nodes and applications. At the same time, without having to move to a different application, users may communicate service requests and incident reports related to their monitored database. Moreover, in one embodiment, the application may be configured to allow a user to enter requests from any cellular data or wireless communication enabled location, which may allow the system to prioritize and address requests and incidents in accordance with a client's service level agreement (SLA).

The system according to the present disclosure may be carried out on various mobile devices, such as tablet computers (e.g., Apple iPad, Samsung Galaxy Tab, etc.), smart phones (e.g., Apple iPhone, Blackberry Phone, Android Phone, etc.), smart watch (e.g., Apple Watch, etc.) Personal Digital Assistants (PDAs), Personal Computer devices (PCs; through web browser and installable software) and other similar devices. The mobile devices may be connected over a network such as a Local Area Network (LAN), Wide Area Network (WAN), digital subscriber line (DSL), wireless networks (e.g., 3G or 4G networks), or other equivalent connection means. In one embodiment, mobile devices may have downloaded a software application or program onto their local device that enables communication with a cloud-based system for database monitoring and service provisions. The mobile devices may communicate over the network using programs or applications (‘App’ or ‘Apps’). In one preferred embodiment, the method of the present disclosure is carried out by an App running on one or more mobile devices.

The term “computing device” as used herein is intended for all purposes to be interpreted broadly and is defined for all uses, all devices, and/or all systems and/or systems in this disclosure as a device comprising at least a central processing unit, a communications device for interfacing with a data network, transitory computer-readable memory, and/or a non-transitory computer-readable memory and/or media. The central processing unit carries out the instructions of one or more computer programs stored in the non-transitory computer-readable memory and/or media by performing arithmetical, logical, and input/output operations to accomplish in whole or in part one or more steps of any method described herein. A computing device is usable by one or more users, other computing devices directly and/or indirectly, actively and/or passively for one or more suitable functions herein. The computing device may be embodied as computer, a laptop, a tablet computer, a smartphone, and/or any other suitable device and may also be a networked computing device, a server, or the like. Where beneficial, a computing device preferably includes one or more human input devices such as a computer mouse and/or keyboard and one or more human interaction device such as one or more monitors. A computing device may refer to any input, output, and/or calculating device associated with providing a virtual reality experience to one or more users. Although one computing device may be shown and/or described, multiple computing devices may be used. Conversely, where multiple computing devices are shown and/or described, a single computing device may be used.

The present disclosure provides a mobile application from which consumers of remote database administrative services can access both database monitoring information (e.g., status updates, alerts, etc.) and service provisioning applications (e.g., ticket entry software, etc.). Various products exist which provide database monitoring and service provision functions. For example, the database monitoring may be provided by one or more software products and/or services available from SolarWinds Worldwide, LLC (Austin, Tex.), such as Server and Application Monitor (SAM). Service functions may be provided by one or more software products and/or services available from ServiceNow (Santa Clara, Calif.).

Database monitoring applications may be configured to monitor client servers and databases through the establishment of secure connectivity to the client's environment. In one embodiment, the database monitoring applications may utilize monitoring templates that are product specific (e.g., SQL, Oracle, DB2 databases). The templates may determine which server application monitor(s) are deployed for a given server or database as well as performance thresholds for that server or database. Performance thresholds may be associated with alert generation. For example, if a performance threshold is set at 90%. If a process utilizes 90% of the available resources, the database monitoring application may generate an alert. The alert may be transmitted to a database operations center, that is configured to respond to the issue in accordance with the client's contractually defined parameters.

Service provisioning applications may be configured to perform database administration tasks from a remote location for a wide variety of relational database systems, automate the reporting of key performance trend information by utilizing a relational database data store and reporting processes, and provide for automated paging notification of remote support personnel without human intervention. In one embodiment, the service provisioning application may be configured to include an ongoing automated threshold monitoring of the database system, a technical assessment of the database environment by experienced database administrators, and the logging of events to a central Database Operations Center (DOC).

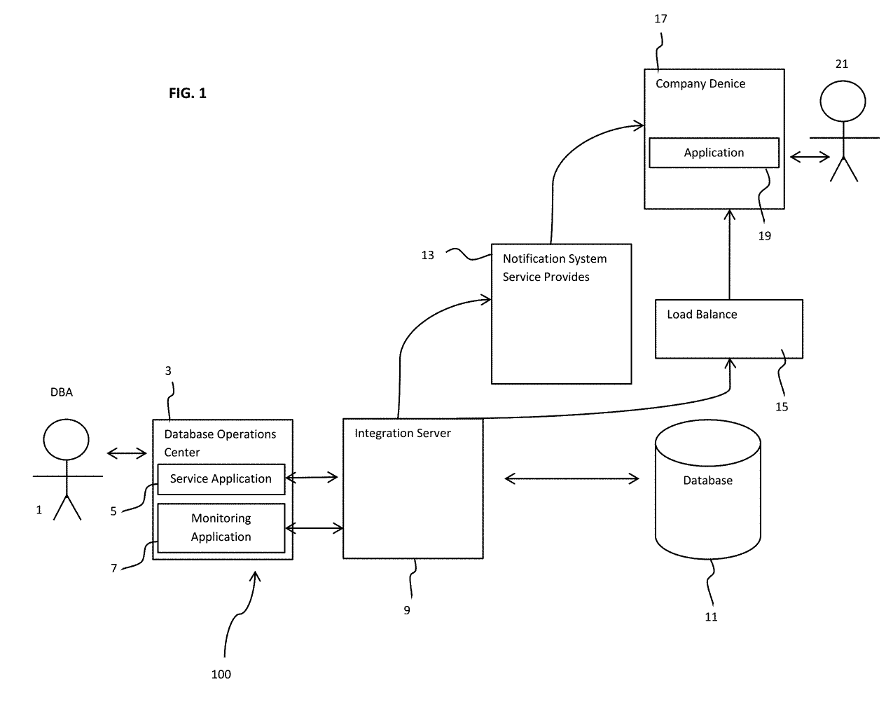

In one embodiment, the database monitoring application and/or the service provisioning application may be configured to communicate to an integration hub via a communication protocol such as REST API. As will be discussed further in connection with FIG. 1, the integration hub may provide information to a mobile user interface.

An embodiment of the present disclosure may be carried out as an App running on one or more computing devices (e.g., smart phone, PC), or alternatively within a web browser running one or more computing devices (e.g., PC). In either case, the method allows for managerial and/or operational users (depending on the task) to: (1) enter routine database maintenance requests; (2) view service provision related information such as open tickets, etc.; (3) modify and personalize user interface settings; (4) enter service requests such as adding a user or updating server information; (5) search for and filter server and database information; and (6) initiate contact with a DBA or other support person.

An embodiment of the present disclosure may include an application that allows a user to enter routine database maintenance requests. In one embodiment, a user may access application from a mobile device, select a request option from the standard catalog available to the customer, fill out the request form with the required information, and then submit the request. The submitted request may be routed from the application on the user device to an integration hub. In one embodiment, the integration hub may include an array of physical and virtual servers and databases. The integration hub may processes the received maintenance request by providing it to a service provisioning application through a communication protocol (such as REST API) that connects the integration hub to the service provisioning application. The service provisioning application may then fulfill the request by creating a record and forwarding notification to one or more service providers. The service provisioning application may then update the integration hub using the communication protocol. The integration hub may update a user's mobile application such that they can see the status of their request.

An embodiment of the present disclosure may also include an application that allows a user to view service provision related information such as open tickets and the like. A user may access application from a mobile device. In the application the user may access either a Requests list or an Incidents list. Based on the user's selection of the requests list or the incidents list, the mobile application may route the user's request to the integration hub. The integration hub may process the request and provide it to a service provisioning application using a suitable communication protocol (such as REST API). The cloud based service provisioning application may then fulfil the user's request by displaying either the user's incidents or requests or the incidents/requests from the entire company. The service provisioning application may then update the integration hub using the communication protocol. The integration hub may update a user's mobile application such that the user can view the list in the mobile application.

An embodiment of the present disclosure may also include an application that allows a user to modify and personalize user interface settings. A user may access an application from a mobile device. In the application the user may select a Settings option from a menu. Once a user selects the Settings option a second page of the application may be displayed to a user. On the second page the user may view the various settings that they are able to configure. These may include (without limitation) settings related to incidents, requests, and the collection of data analytics. The incident settings may specify whether a user wishes to receive notifications (e.g., push notifications) on the user's computing device when an incident that the user created or is on the watch list for is updated. The request settings may specify whether a user wishes to receive notifications (e.g., push notifications) on the user's computing device when a request the user made is updated with a status change or with comments. The collect analytics data settings may specify whether the user wishes to transmit usage data to an administrator of the system. By opting to send analytics data, the administrator of the system may view usage trends that can be used to modify the system. In one embodiment the user may select the appropriate settings using a slider, button, checkbox, and the like. Once the user has selected the appropriate settings, a request may be routed from the user's computing device to the integration hub. The integration hub may then store the settings and process future requests in accordance with the settings. In one embodiment, the default settings may be to provide notifications to a user for both requests and incidents, and provide collected analytics data to a system administrator.

An embodiment of the present disclosure may include an application that allows a user to enter service requests such as adding a user or updating server information. In one embodiment, a user may access application from a mobile device, select a request option from the standard catalog available to the customer, fill out the request form with the required information, and then submit the request. The submitted request may be routed from the application on the user device to an integration hub. In one embodiment, the integration hub may include an array of physical and virtual servers and databases. The integration hub may processes the received maintenance request by providing it to a service provisioning application through a communication protocol (such as REST API) that connects the integration hub to the service provisioning application. The service provisioning application may then fulfill the request by creating a record and forwarding notification to one or more service providers. The service provisioning application may then update the integration hub using the communication protocol. The integration hub may update a user's mobile application such that they can see the status of their request.

An embodiment of the present disclosure may include an application that allows a user to search for and filter server and database information. After a user accesses an application from a mobile device, they may be routed to a home page that displays a collection of nodes. The user may then tap the display of nodes, or from a menu, select an option that displays the collection of nodes. The selection to view the collection of nodes may be routed from the user's computing device, via the integration hub, to a database monitoring application. The database monitoring application may retrieve a list of nodes (or servers) and provide them to the integration hub via a suitable communication protocol. The integration hub may then update a user's mobile application display the list of retrieved nodes and their related information. The user may use the mobile application's search and filtering capabilities in order to search and filter the list of nodes. The mobile application may also provide the user with a list of applications (i.e., databases) associated with each server. In contrast to conventional systems, in this manner the user may be provided with the ability to search and filter nodes.

An embodiment of the present disclosure may include an application that allows a user to initiate contact with a DBA or other system administrator. A user may access the application from a mobile device. The user's login action may pull the related information from the integration hub, including the DBAs assigned to the company and the email and phone contact information for a system administrator such as an assigned customer support specialist. The user may access this information by selecting a Contacts screen within the mobile application. From the contacts screen the user can directly email or phone the customer support specialist, or phone the database operations center.

Mobile Application Architecture Overview

FIG. 1 illustrates computer architecture for a system with integrated database monitoring and service provisions according to an aspect of the present disclosure. In particular, an exemplary connectivity model between a provider of remote database administration, and a mobile device user (customer) is shown.

As illustrated in FIG. 1, a system with integrated database monitoring and service provisions 100 may include Data Base Administrators (DBAs) or administrators 1 stationed at a Database Operations Center (DOC) 3. These administrators 1 are internal to the database services provider and have access to software for database monitoring, alerting, and provision of service functions via the DOC 3. In one embodiment the DOC 3 may include a monitoring application 7 (e.g., SolarWinds Server Application Monitor) and a service provisioning application 5 (e.g., ServiceNow).

The monitoring application 7 may be a hosted application that serves as the monitoring interface and backend architecture through which the remote database monitoring is achieved. Monitoring information may be conveyed to a mobile application 19 from a at least one server including an integration hub (alternatively, integration server) 9 that resides within the service provider's network.

In one embodiment, the integration hub 9 receives information configured in the monitoring application 7 for a specific product line (e.g. SQL, Oracle, etc.). The product line may vary across customers, or across servers in a customer's environment. The monitoring application 7 may provide the integration hub 9 with an indication of the status of each database associated with the customer. Status indicators may include up, down, warning, and the like. The monitoring application 7 may also provide the integration hub 9 with a list of components of the databases that have problems (e.g., indication that a specific process is down, a backup check is not working). Additionally, the monitoring application 9 may provide the integration hub 9 with the status of each of the customer's nodes (servers) and the CPU load and memory used for each node. The integration hub 9 may interface with the application 19 on the company device 17 in order to provide the user 21 with monitoring information.

In one embodiment the application 19 may be coded in a multi-platform development tool (e.g., Xamarin) that is compatible across various operating systems (e.g., iOS, Android). The information provided by the monitoring application 7 to the integration hub 9 may be in HTML format and sent by any suitable communication method such as REST API.

Monitoring information provided by the monitoring application 7 to the integration hub 9 may be provided to the integration hub 9 by a one-way pathway (e.g., REST API). In one embodiment the monitoring information provided to the integration hub 9 may be in a read-only format and not editable by the integration hub 9. The integration hub 9 may then process the received monitoring information and provide the necessary portions to the mobile application 19 for viewing by the end user 21. In one embodiment, the integration hub 9 may also utilize REST API to transmit the necessary portions of processed monitoring information to the mobile application 19 for viewing by the end user 21.

The service application 5 is a service provision tool that may be used both internally by the database services provider, and also externally by their clients (e.g., the database owners). The database owners may access the service application 5 through a separate portal (e.g., a customer support portal) with limited functions, as compared to the portal available to the database services provider. The service application 5 provides the mobile application 19 with all the service provision and operational support options.

Using the mobile application 19 and integration hub 9 a user 21 may add new users to an instance of the service provisioning application 5, request meeting with a system administrator, enter support tickets for specific problems and request a variety of database related tasks, including, but not limited to routine maintenance, addition or removal of monitoring from servers or databases, monitoring blackouts, setting up high availability on a database, requesting performance tune-ups, and requesting product specific items such as MSSQL Business intelligence projects and features.

In one embodiment the service provisioning application 5 may be bi-directionally communicatively coupled to the integration hub 9. The service provisioning application 5 may be configured to receive REST API calls from the integration hub 9 and may be configured to provide notifications related to requests, incidents and users to the integration hub 9.

The integration hub or server 9 receives incoming requests and changes made in the mobile application 18 by way of a suitable communication protocol (e.g., REST API). The integration hub 9 may also receive updates from the service provisioning application 5 by way of a suitable communication protocol (e.g., REST API). The integration hub 9 may also receive read-only monitoring data from a monitoring application 7.

Responsive to receiving a service request from the mobile application 19 via the integration hub 9, the service application 5 may update the service application's database tables accordingly, provide notifications to one or more administrative users 1 of the database operations center 3. The service application 5 may then provide the integration hub 9 and subsequently the mobile application with updates related to the service request.

Application Program Interfaces APIs may be configured to connect the monitoring application 7 and the service application 5 to an integration server 9. Specifically, the APIs provide a backend mechanism through which the integration server 9 can communicate with the servers associated with the monitoring application 7 and the service application 5.

The integration server 9 communicates with the mobile application 19 through a separate protocol (e.g., the Representational State Transfer (REST) protocol). In addition, the integration server 9: (a) creates HTTPS connections to the servers associated with the monitoring application 7 and the service application 5 (not the individual servers associated with the user 21) by utilizing the corresponding APIs, (b) connects to a notification system, such as Amazon's Simple Notification Service (SNS) and/or Google's Firebase Cloud Messaging, to send push notifications when ticket states are changed in the service application 5, (c) uses credentials from the service application 5 to validate the mobile application user's credentials and (d) routes mobile application requests to either the monitoring application 7 or the service application 5, depending on the request type.

The integration server 9 may create HTTPS connections with the service application 5 and monitoring application 7 as transactional requests are made from the mobile application 19. Status updates, incident updates, as well as any updates to the service 5 or monitoring applications 7 may be transmitted using the HTTPS connections. This may also include the addition of new servers or new databases, new users, new server information, new additions to monitoring and the like.

In one embodiment the integration server 9 may receive notification that a ticket state has changed and notify a user. If a ticket state is changed the integration server 9 is notified either from the service application 5 or from the mobile application 19 (if the state was modified on the mobile device 17). The integration server 9 then updates the mobile application 19 via the REST API. The user 21 may then see a visual indicator in the menu area as well as in the notifications list. In one embodiment, if the mobile application 19 is not open or displayed in the device 17 the notification appears on the home screen of the mobile device 17.

In one embodiment, prior to using the system 100, a user 21 may have to provide or create accounts and credentials associated with the service application 5 and/or the monitoring application 7.

In one embodiment the integration hub 9 is configured to recognizes whether an incoming item is a Request or an Incident, the two primary form/data types used by users 21.

As noted above, the system 100 may be configured to provide notifications to client 21. In one embodiment the integration server 9 may serve as a conduit to push real-time notification messages from the service application 5 to users of the mobile application 19. A service such as Amazon's Simple Notification Service (Amazon SNS) may be used as the notification system service provider 13.

As illustrated in FIG. 1, the mobile application 19 may be configured to communicate with the integration hub 9 to provide the following features: (a) user authorization and session management through the user's credentials with the service application 5, and (b) receipt of push notifications from the notification system service provider 13 to inform users of updates to subscribed items. Additionally, the mobile application 19 may be configured to (a) communicate with the integration hub 9 via a specific protocol (e.g., the REST API protocol), (b) work with operating systems of the user computing device 17, and (c) enables a native interface on the user computing device 17.

The system 100 shown in FIG. 1 also includes end users or groups of end users 21, such as operations or management users. The operations and management user groups 21 represent two primary end user audiences for which the mobile application 19 is designed. Those of ordinary skill in the art will realize that these two user classifications are only exemplary, and that any number of user groups may be designated using the capabilities of the service application 5.

The mobile application 19 presents various screens to the user 21 to facilitate the various functions of the system 100 shown in FIG. 1. For example, the mobile application 19 may provide the user 21 with the ability to perform administrative functions such as login, and settings. The mobile application 19 may also provide the user 21 with the ability to perform database and server health functions by providing a home page summary, and a nodes summary. The mobile application 19 may also provide the user 21 with the ability to view incidents, requests, and a service catalog. The mobile application 19 may also provide the user 21 with the ability to connect to a DBA 1 or an administrator of the system 100.

In one embodiment the load balancer 15 may be configured to optimize resource use, optimize throughput, minimize response time and avoid overload of any single resource in the system 100.

In one embodiment, the database 11 may store customer or user information related to the service application 5. In one embodiment a relational database structure such as a MySQL database, or more specifically a MariaDB may be used.

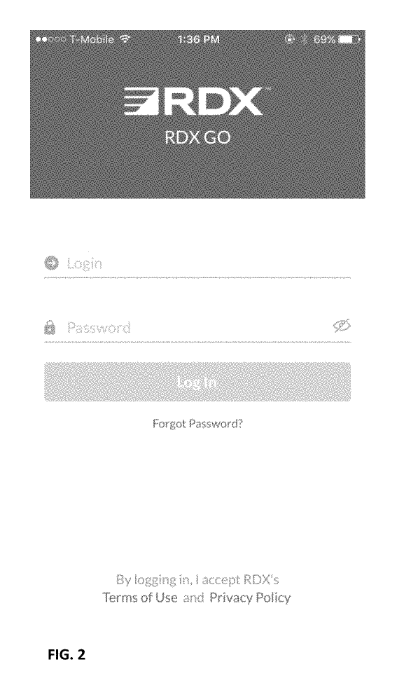

FIGS. 2-10 show exemplary screenshots of a mobile application with integrated database monitoring and service provisions in accordance with the present disclosure. The mobile application 19 combines the characteristics of a database monitoring application 7 (e.g., SolarWinds SAM) and a service application 5 (e.g., ServiceNow) into a single, mobile point of access that duplicates and enhances common desktop tasks from both applications. This mobile application is novel in that it provides consumers with a single point from which to access monitoring information and initiate service requests.

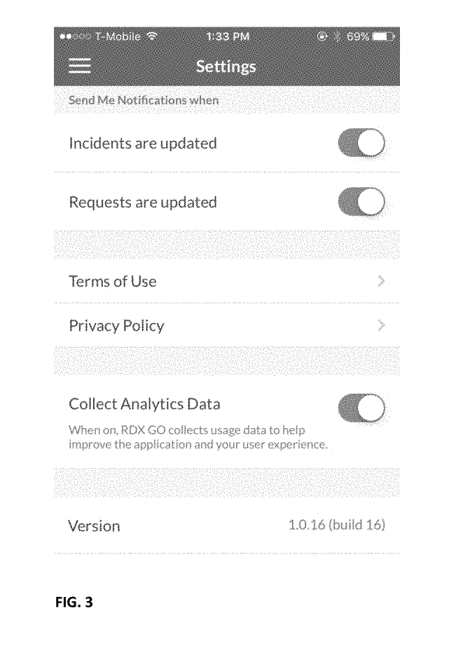

FIGS. 2 and 3 show the administrative options in the mobile application. In particular FIG. 2 illustrates the login page. When a user provides their credentials on the login page, their credentials are validated and access to the application is enabled. Requesting a new account may be equivalent to requesting a new user. A new user request may be received by the integration hub 9 from the user 21 and then forwarded to the service application 5 who then forwards it to an administrator 1.

FIG. 3 illustrates the settings page, which enables users to control the types of push notifications that they receive. In one embodiment a user may control settings related to change notifications, incident notifications, and data collection. In one embodiment, the system may include a usage data collection module that collects anonymous usage statistics and provides it to the administrator 1 via an intermediary application within the system 100. The collected data may be utilized by the administrator 1 to understand usage trends and statistics and analyze usage patterns for the purpose of improving future versions of the application 19.

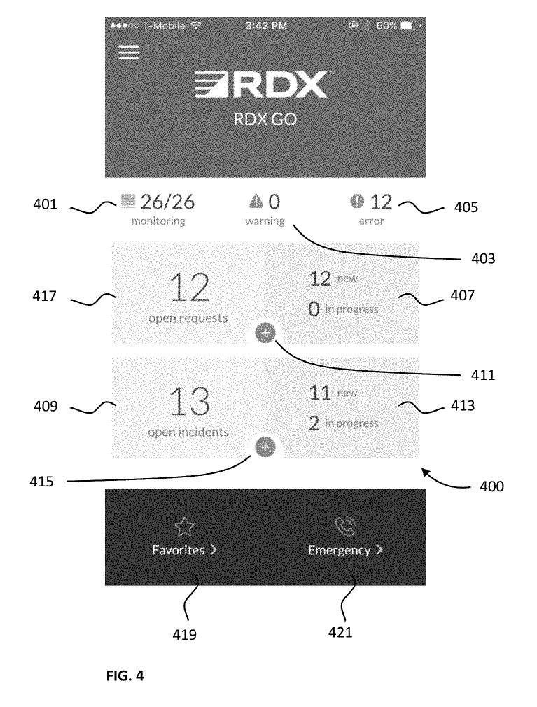

FIG. 4 show the application's homepage 400 which displays a real-time status update of the client's monitored servers/databases. As illustrated in FIG. 4, the homepage 400 may include a display of the nodes monitored and total nodes in a user's environment 201, a display of the total number of status requests from users affiliated with a particular organization 417, a display of the total number of nodes in a warning state 403, a display of the total number of nodes in an error state 405, a display of a breakdown of requests by new or in-progress status 407, a display of the total number of open incidents for an organization 409, a create new request button 411, a display of breakdown of incidents by new or in-progress status 413, and a create new incident button 415. The homepage 400 may also include a favorite list 419 and a link to the ability to make a phone call to a support desk 421.

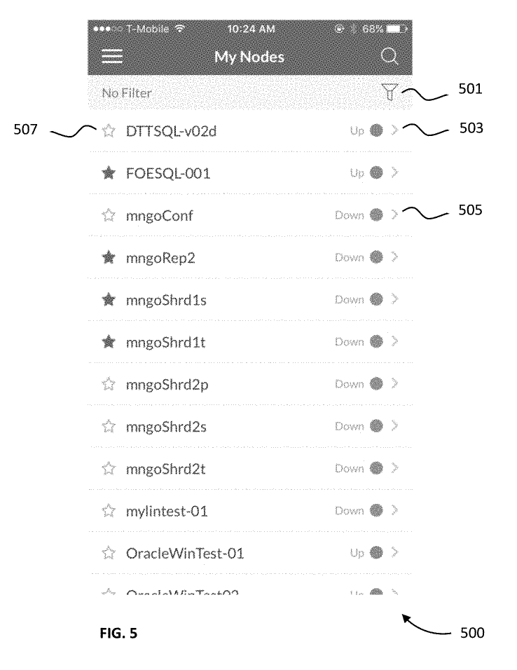

FIG. 5 shows a My Nodes page, which lists all of the user's nodes 500 and provides an indication of the status of the node (server). The nodes page 500 includes a filter 501 that allows a user to filter nodes by status (e.g., up, down, warning, etc.), operating system (e.g., Windows, Unix/Linux, etc.) and system type. The nodes page 500 also includes a status indicator for a node 503, 505. A user may also favorite/un-favorite a node by selecting/deselecting an icon 507. Favorites may be viewed in a separate list 419 from the home page 400.

Data and information displayed in FIGS. 4 and 5 may be acquired by the mobile application's communication link to the service provider's database monitoring tool, e.g., SolarWinds.

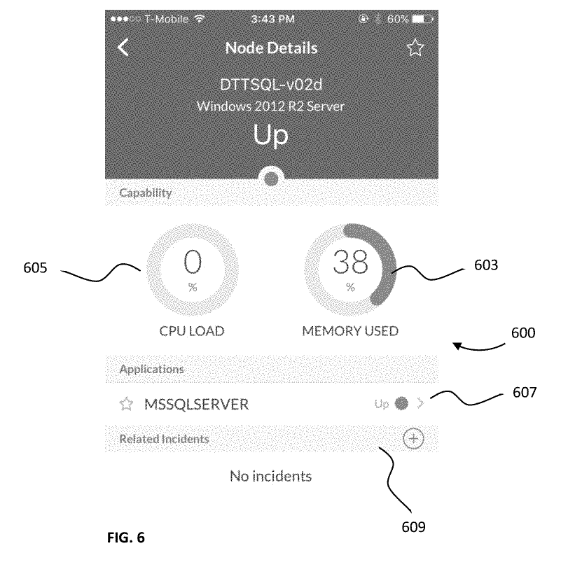

FIG. 6 illustrates the view of an individual node (server) 600, from which a user can see the status of the applications (databases) on the node, as well as any incidents associated with the node. Per standard mobile interactivity, users can swipe downward to refresh data, or tap on any of the list items to view information.

As illustrated in FIG. 6, information may include the percentage of memory used on the node 603, the percentage load on the node's central processing unit (CPU) 605, the status of the application(s) on the node 607, and a list of related incidents 609. The list of related incidents 609 may correspond to the tickets that were submitted for the node. In one embodiment, new tickets may be submitted by tapping the ‘+’ icon.

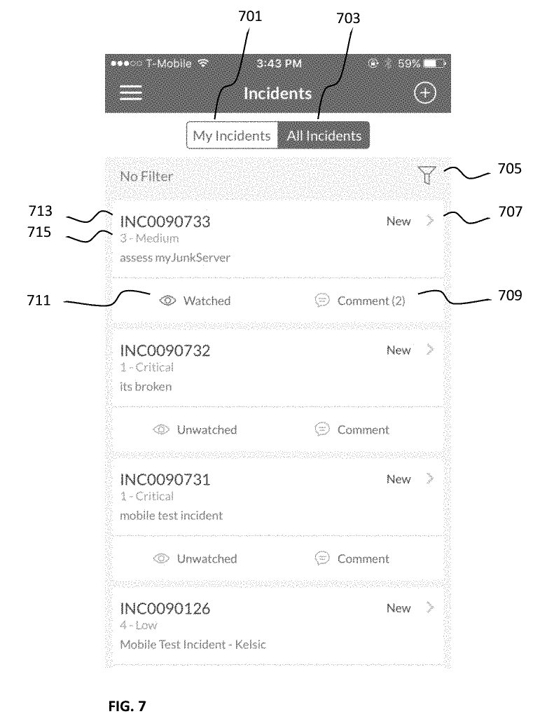

FIG. 7 illustrates a My Incidents page 700 of the mobile application that includes a filterable list that allows a user to view and edit all of the incidents that they reported, as well as to view all of the incidents reported by users from their organization. Users can also enter a support ticket from this view.

Incident information such as date and time, status, the caller (who entered the ticket), comments added to the ticket, attachments added to the ticket, and any users on the watch list for the ticket may be visible after selecting an incident from the My Incidents page 700.

A support ticket may include information related to priority, status, caller, opened (time and date information), closed (time and date information), description, watchlist, attachments, and additional comments. The time and date information for the opened or closed items in a support ticket may be automatically generated.

The My Incidents page 700 may display a list of incidents submitted by a user 701, a list of incidents entered by the user's company 703, a filter option to filter incidents by status 705, an incident listing (that provides incident information when selected) 707, a comment area 709 configured to allow a user to view existing comments, and add new comments, a watched/unwatched icon 711 that allows a user to add/remove themselves from a watch list, an indication of corresponding service application 5 incident numbers and priority/incident name previews 715 for incident list items.

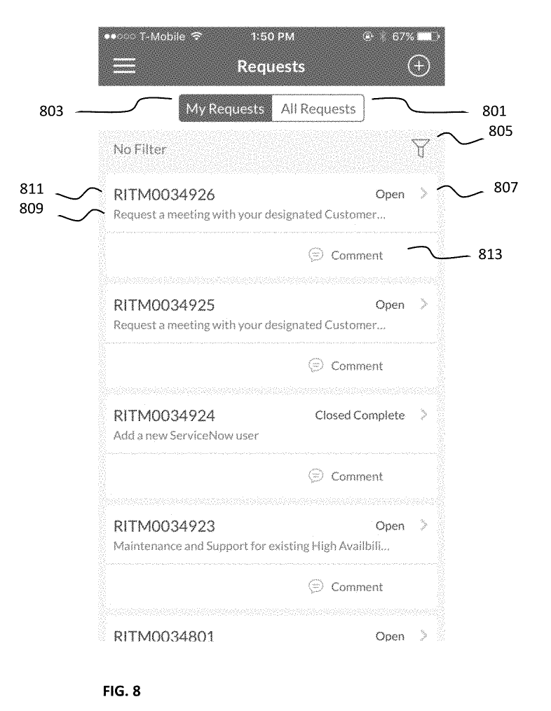

FIG. 8 illustrates a My Requests page 800 of the mobile application that includes a filterable list that enables users to see all requests that they made, as well as those made by users from their organization. The My Requests page 800 may include a list view all requests made by a user's company 801, a list view of requests submitted by a user 803, a filter option 805 to filter by status, an option to view more information about a request (open a request) 807, standard title for request type included in list view 809, a corresponding service application 5 request number 811, and a comment area 813 configured to allow a user to view existing comments, and add new comments.

Users can also enter a new request from this view. A new request form may include details such as the status of the request, the stage of the request, the requestor, the due date and time, order number, a description for the request, attachments and comments.

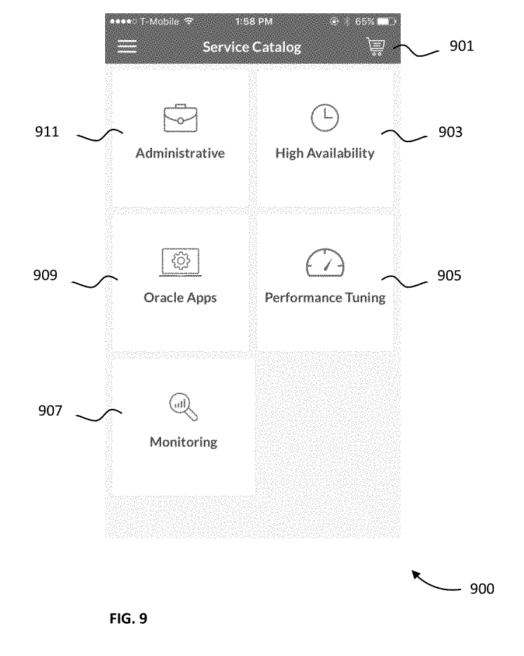

FIG. 9 illustrates a Service Catalog page 900 of the mobile application that provides users with the same database service options that they see in the desktop view of the service application 5.

The Service Catalog page 900 may provide the user with a listing of service options such as administrative tools 911, availability 903, oracle applications 909, performance tuning 905, and monitoring 907. The Service Catalog page 900 may also include a shopping cart 901 where users can collect and purchase service options.

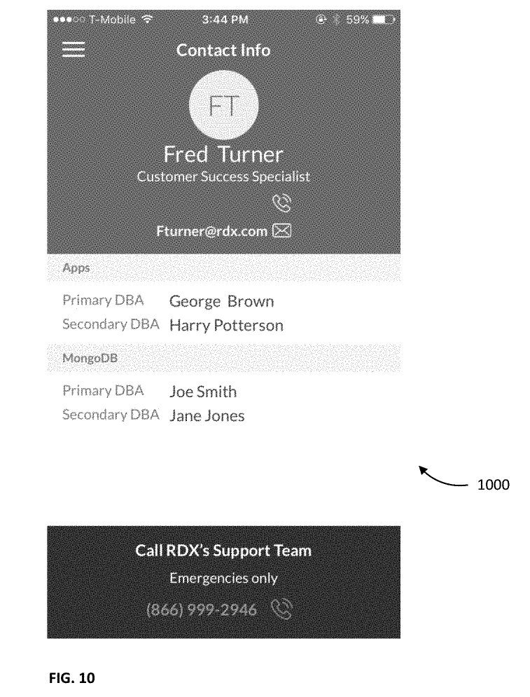

FIG. 10 illustrates a contact page 1000 of the mobile application that provides users with the contact information for an administrator of the system 100 illustrated in FIG. 1.

Although the disclosure has been described in terms of exemplary embodiments, it is not limited thereto. Rather, the appended claims should be construed broadly to include other variants and embodiments of the disclosure which may be made by those skilled in the art without departing from the scope and range of equivalents of the disclosure. This disclosure is intended to cover any adaptations or variations of the embodiments discussed herein.

1. An system comprising:
at least one user computing device including an application; and
at least one server communicatively coupled to each of the at least one computing device via a network, the at least one server comprising a non-transitory memory storing computer-readable instructions and at least one processor, execution of the instructions, by the at least one processor, causing the at least one server to:
retrieve monitoring information related to at least one database via a monitoring application;
retrieve service information related to the at least one database via at least one of a service application and the at least one user computing device;
generate integrated information that includes the monitoring information with the service information; and
provide, on the at least one user computing device, a graphical user interface in the application that displays the integrated information.

2. The system of claim 1 further comprising:
receiving, via the graphical user interface, a monitoring request; and
retrieving the monitoring information related to the at least one database via the monitoring application responsive to the received monitoring request.

3. The system of claim 1 further comprising:
receiving, via the graphical user interface, a service request;
transmitting, from the at least one server to the service application, the service request; and
retrieving the service information related to the at least one database via at least one of a service application and the at least one user computing device responsive to the service request.

4. The system of claim 1, wherein the integrated information further comprises:
at least one of node status, request information, node information, and incident information.

5. The system of claim 1 further comprising:
a monitoring application configured to track user usage and adjust the graphical user interface based on the user usage.

6. The system of claim 4, wherein node information further comprises at least one of CPU load, memory usage, application information, and related incidents.

7. The system of claim 4, wherein incident information further comprises at least one of date and time information for a ticket corresponding to an incident, information related to who constructed the ticket, comments associated with the ticket, attachments associated with the ticket, and users who are associated with the ticket.

8. A method comprising:
retrieving, via at least one server, monitoring information related to at least one database via a monitoring application, wherein the at least one server is communicatively coupled to each of at least one computing device via a network, the at least one server comprising a non-transitory memory storing computer-readable instructions and at least one processor, the at least one computing device including an application;
retrieving, via the at least one server, service information related to the at least one database via at least one of a service application and the at least one user computing device;
generating integrated information that includes the monitoring information with the service information; and
providing, on the at least one user computing device, a graphical user interface in the application that displays the integrated information.

9. The method of claim 8 further comprising:
receiving, via the graphical user interface, a monitoring request; and
retrieving the monitoring information related to the at least one database via the monitoring application responsive to the received monitoring request.

10. The method of claim 8 further comprising:
receiving, via the graphical user interface, a service request;
transmitting, from the at least one server to the service application, the service request; and
retrieving the service information related to the at least one database via at least one of a service application and the at least one user computing device responsive to the service request.

11. The method of claim 8, wherein the integrated information further comprises:
at least one of node status, request information, node information, and incident information.

12. The method of claim 8 further comprising:
tracking user usage based on a monitoring application of the at least one server; and
adjusting the graphical user interface based on the tracked user usage.

13. The method of claim 11, wherein node information further comprises at least one of CPU load, memory usage, application information, and related incidents.

14. The method of claim 11, wherein incident information further comprises at least one of date and time information for a ticket corresponding to an incident, information related to who constructed the ticket, comments associated with the ticket, attachments associated with the ticket, and users who are associated with the ticket.

15. A system comprising:
a database operations center further comprising a service application and a monitoring application; and
an integration hub comprising at least one server communicatively coupled to the database operations center and a separate computing device having an application, the at least one server comprising a non-transitory memory storing computer-readable instructions and at least one processor,
execution of the instructions, by the at least one processor, causing the at least one server to:
receive from the separate computing device at least one request;
determine whether the received request is a monitoring request or a service request;
query the service application of the data operations center for service information if it is determined that the received request is the service request and receive the service information;
query the monitoring application of the data operations center for monitoring information if it is determine that the received request is the monitoring request and receive the monitoring information;
display on a graphical user interface of the application of the separate computing device integrated information related to the service application and the monitoring application; and
update a graphical user interface on the application of the separate computing device with at least one of the service information and the monitoring information.

16. The system of claim 15, wherein the integrated information further comprises:
at least one of node status, request information, node information, and incident information.

17. The system of claim 15 wherein the integration hub further comprises:
a monitoring application configured to track user usage and adjust the graphical user interface based on the user usage.

18. The system of claim 16, wherein node information further comprises at least one of CPU load, memory usage, application information, and related incidents.

19. The system of claim 16, wherein incident information further comprises at least one of date and time information for a ticket corresponding to an incident, information related to who constructed the ticket, comments associated with the ticket, attachments associated with the ticket, and users who are associated with the ticket.
